(19) United States
(12) Patent Application Publication
(10) Pub. No.: US 2016/0260076 A1
(43) Pub. Date: Sep. 8, 2016

(54) COMMODITY INFORMATION PROCESSING APPARATUS AND SYSTEM

(71) Applicant: TOSHIBA TEC KABUSHIKI KAISHA, Tokyo (JP)

(72) Inventors: Katsuhito MOCHIZUKI, Tagata Shizuoka (JP); Mahina NAKAMURA, Mitaka Tokyo (JP); Yumiko OKUMA, Nakano Tokyo (JP); Yasutsugu SASAKI, Yokohama Kanagawa (JP)

(21) Appl. No.: 15/057,860

(22) Filed: Mar. 1, 2016

(30) Foreign Application Priority Data
Mar. 2, 2015 (JP) 2015-039911

(51) Int. Cl. G06Q 20/20; H04N 1/00; G06K 7/14

(52) U.S. Cl. CPC G06Q 20/209; G06K 7/1417; H04N 1/00103

(57) ABSTRACT

A point of sale apparatus includes a scanner for scanning a code on a commodity, a communication interface, and a processor. The apparatus retrieves commodity data based on the scanned code, the commodity data including a name and a price of the commodity. The processor generates a first receipt information based at least on the retrieved commodity data. The first receipt information is transmitted to a printer for printing a paper receipt that includes the name and price of the commodity. The processor converts the first receipt information to a second receipt information having a different format from the first receipt information. The apparatus retrieves classification data corresponding to the commodity based on the second receipt information, the classification data including data not included in the first receipt information. A storage unit stores the classification data in correspondence with the second receipt information.

### CROSS-REFERENCE TO RELATED APPLICATION

This application is based upon and claims the benefit of priority from Japanese Patent Application No. 2015-039911, filed Mar. 2, 2015, the entire contents of which are incorporated herein by reference.

### FIELD

Embodiments described herein relate generally to a commodity information processing apparatus and system.

### BACKGROUND

An electronic receipt mechanism is known in which a receipt or voucher delivered to a customer is electronically transferred to a portable terminal of the customer from a store after the settlement of commodities.

Based on the electronic receipt information obtained by providing receipt information as electronic data, a household account book can be kept electronically and automatically, which is beneficial to the customer. Moreover, by introducing the electronic receipt mechanism, the consumption of receipt paper in a store is reduced, which is also beneficial to the store into which the electronic receipt mechanism is introduced.

However, according to the conventional electronic receipt mechanism, the content printed on a paper receipt is generated as an electronic receipt. Because of the limitation to the size of the paper receipt, only a small amount of necessary information is recorded on the paper receipt. Other contents different from those printed on the paper receipt is not processed by the conventional electronic receipt receiving apparatus (software), thus leading to a problem of low efficiency in data utilization.

### DESCRIPTION OF THE DRAWINGS

FIG. 1 is a diagram illustrating the structure of an electronic receipt system according to an embodiment;

FIG. 2 is a block diagram illustrating the structure of a POS terminal;

FIG. 3 is a diagram illustrating the data structure of an extended data file;

FIG. 4 is a block diagram illustrating the structure of an electronic receipt server;

FIG. 5 is a block diagram illustrating the structure of an electronic receipt management server;

FIG. 6 is a block diagram illustrating the structure of a portable terminal;

FIG. 7 is a block diagram illustrating functional sections of a POS terminal relating to an electronic receipt processing;

FIG. 8 is a diagram schematically illustrating receipt information;

FIG. 9 is a diagram schematically illustrating electronic receipt information;

FIG. 10 is a diagram schematically illustrating electronic receipt information added with extended data;

FIG. 11 is a flowchart illustrating the procedures of an electronic receipt processing carried out by a POS terminal;

FIG. 12 is a block diagram illustrating the functional sections of an electronic receipt management server relating to an electronic receipt management processing and an information sending processing;

FIG. 13 is a diagram schematically illustrating extended data in an unstructured format;

FIG. 14 is a flowchart illustrating the procedures of the electronic receipt management processing and the information sending processing carried out by the electronic receipt management server;

FIG. 15 is a block diagram illustrating the functional sections of a portable terminal relating to an electronic receipt receiving processing and an electronic receipt browsing processing;

FIG. 16 is a flowchart illustrating the procedures of the electronic receipt receiving processing and the electronic receipt browsing processing carried out by a portable terminal; and

FIG. 17 is a diagram illustrating the electronic receipt information displayed on a display section of the portable terminal.

### DETAILED DESCRIPTION

In accordance with an embodiment, a point of sale apparatus includes a scanner for scanning a code on a commodity, a communication interface, and a processor. The apparatus retrieves commodity data based on the scanned code, the commodity data including a name and a price of the commodity. The processor generates a first receipt information based at least on the retrieved commodity data. The first receipt information is transmitted to a printer for printing a paper receipt that includes the name and price of the commodity. The processor converts the first receipt information to a second receipt information having a different format from the first receipt information. The apparatus retrieves classification data corresponding to the commodity based on the second receipt information, the classification data including data not included in the first receipt information. A storage unit stores the classification data in correspondence with the second receipt information.

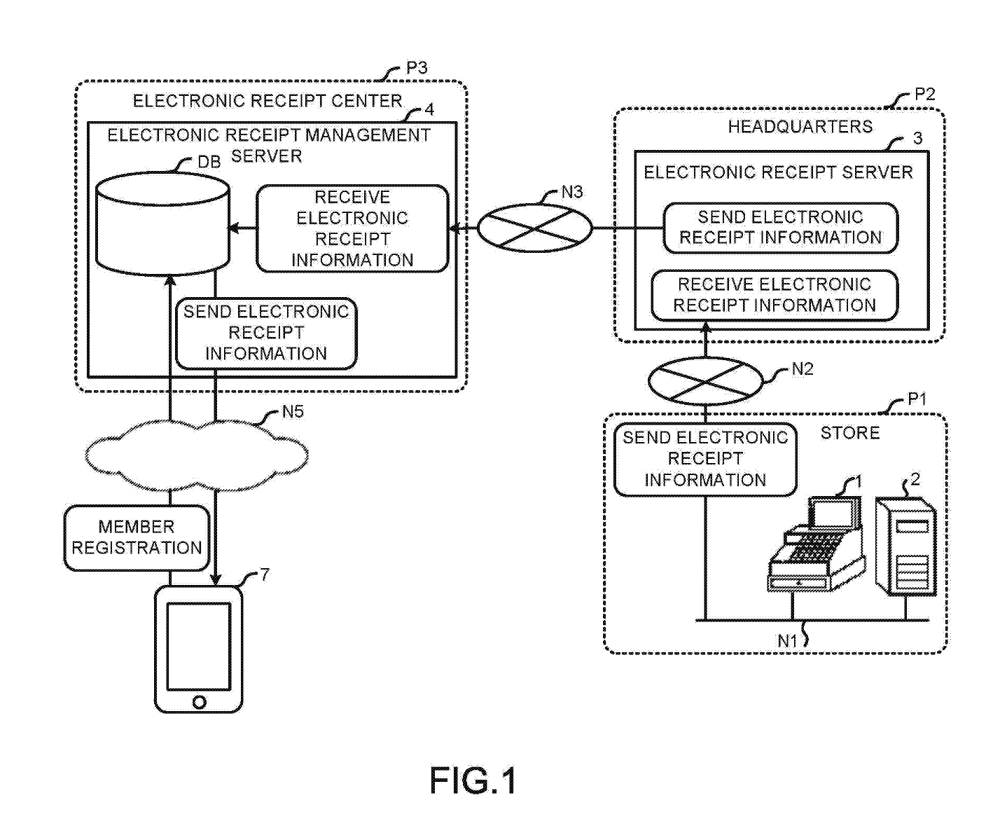

FIG. 1 is a diagram illustrating the structure of an electronic receipt system according to the embodiment. As shown in FIG. 1, an electronic receipt system comprises a POS (Point of Sales) terminal 1, a store server 2, an electronic receipt server 3, an electronic receipt management server 4 and a portable terminal 7.

The POS terminal 1 and the store server 2 are arranged in a store P1. The POS terminal 1 and the store server 2 are connected with each other in a communicable manner through an in-store network N1. The network N1 may be, for example, a Local Area Network (LAN). Further, the POS terminal 1 and the store server 2 can be connected with a network N2 which connects the store P1 with the headquarters P2 via a network device (not shown) such as a router connected with the in-store network N1. Herein, the network N2 is a dedicated line such as an Internet or a Virtual Private Network (VPN).

The POS terminal 1 functions as an output control apparatus and a sales data processing apparatus of the present embodiment to carry out a commodity sales data processing. The POS terminal 1 generates receipt information containing the transaction content of a commodity serving as a settlement object, and prints the receipt information with the use of a printer 13 described later, thereby outputting a paper receipt. The receipt information includes information relating to the content of a transaction, including a commodity name, a commodity code and a price of each commodity serving as a settlement object.

The POS terminal 1 outputs electronic receipt information resulting from the conversion of the data format of the receipt information to the electronic receipt server 3 via the network N2. Not limited to be sent with the use of a specific method, the electronic receipt information may also be sent in accordance with a general protocol such as HTTP or HTTPS. A plurality of POS terminals may be provided in the store P1 because no specific limitations are given to the number of the POS terminals 1 arranged in the store P1.

The store server 2 collectively manages the processing such as a commodity sales data processing carried out by each POS terminal 1. For example, the store server 2 stores and manages commodity sales data generated by the commodity sales data processing carried out by the POS terminal 1 and a commodity data file used during the commodity sales data processing.

A plurality of POS terminals maybe arranged in the store P1. Further, it is described in the present embodiment that electronic receipt information is output from the POS terminal 1; however, the present invention is not limited to this. For example, the store server 2 or a conversion module (not shown) may carry out a data format conversion processing to convert the receipt information generated by the POS terminal 1 into electronic receipt information and output the resulting electronic receipt information to the electronic receipt server 3.

The electronic receipt server 3 is arranged in the headquarters P2 of a company that runs stores or chain stores (hereinafter referred to as ‘stores’) and functions as a receipt management server to manage the electronic receipt information of each company that runs stores. The electronic receipt server 3 has functions of the sales management, sales analysis and inventory management for the company that runs the store.

The electronic receipt server 3 receives the electronic receipt information sent from the POS terminal 1 via the network N2. Further, the electronic receipt server 3 sends (transmits) the received electronic receipt information to the electronic receipt management server 4 via a network N3 which connects the headquarters P2 with an electronic receipt center P3.

The network N3 is a dedicated line such as the Internet or a VPN. By way of example, the electronic receipt information may be sent in accordance with a general protocol such as HTTP or HTTPS, although the present invention is not so limited.

The electronic receipt management server 4 is arranged in the electronic receipt center P3. The electronic receipt center P3 maybe managed by a third-party organization other than the company which manages the electronic receipt information with the use of the electronic receipt server 3. Additionally, the electronic receipt server 3 may also be managed by the third-party organization.

The electronic receipt management server 4 functions as a receipt management server for customer which is used to collectively manage the electronic receipt information of various companies that run the stores. The electronic receipt management server 4 stores and manages member data of each customer (member) who carries out a member registration operation (through procedures described below). The electronic receipt management server 4 stores the member data, including name and the member code of the customer (member) and the sending destination information (e.g. the email address) of a portable terminal 7 to which electronic receipt information is to be sent, in a member master file retained in a database (DB). Herein, the member code functions as specification information for specifying the customer (member). Further, a member management server may be used instead of the electronic receipt management server 4 to store and manage member data.

Further, the electronic receipt management server 4 receives the electronic receipt information sent from the electronic receipt server 3 via the network N3 and stores and manages the electronic receipt information in an electronic receipt management area 43a in the database DB (described further below). More specifically, in addition to the transaction content (commodity sales data) of a commodity, the electronic receipt information further includes elements such as a member code and the like so that the electronic receipt information can be managed in association with the member data of a corresponding member.

Further, if the electronic receipt information is stored in the database DB, then the electronic receipt management server 4 specifies a sending destination (a portable terminal 7) by reference to sending destination information associated with the member code included in the electronic receipt information. Moreover, the electronic receipt management server 4 sends the electronic receipt information stored in the database DB to the sending destination via a network N5, as will be described later.

Further, if an inquiry of the electronic receipt information about the designation of a member code is received from the portable terminal 7 connected via the network N5 described later, the electronic receipt management server 4 extracts, from the database DB, electronic receipt information corresponding to the member code and sends the extracted electronic receipt information to the portable terminal 7.

The portable terminal 7 may be, for example, a terminal device such as a smart phone, a mobile phone, a PDA (Personal Digital Assistant) or a tablet computer, and is used by the user (customer) of the present system. Applications such as, for example, a Web browser for browsing various kinds of information provided on the network N5 are installed on the portable terminal 7. In addition to the portable terminal 7, a terminal device such as a PC is also applicable.

The portable terminal 7 can access the electronic receipt management server 4 via the network N5 to carry out a member registration to the present system. The network N5 is the Internet or various public networks.

The member registration of the customer to the present system is carried out by, for example, the following procedures: the customer sends an empty email from the portable terminal 7 to the electronic receipt management server 4 via the network N5. The electronic receipt management server 4 sends a Uniform Resource Locator (URL) indicating a page for the member registration to the received email address. The customer accesses the URL indicating a page for the member registration from the portable terminal 7 to display an input screen on which items (name, sending destination information and the like) needed for the member registration are input. After the customer inputs the needed items, the electronic receipt management server 4 carries out a member registration with respect to the member master file. Sequentially, the electronic receipt management server 4 sends a member registration completion email containing a member code (customer code) and a password to the portable terminal 7. Then, the member registration is ended.

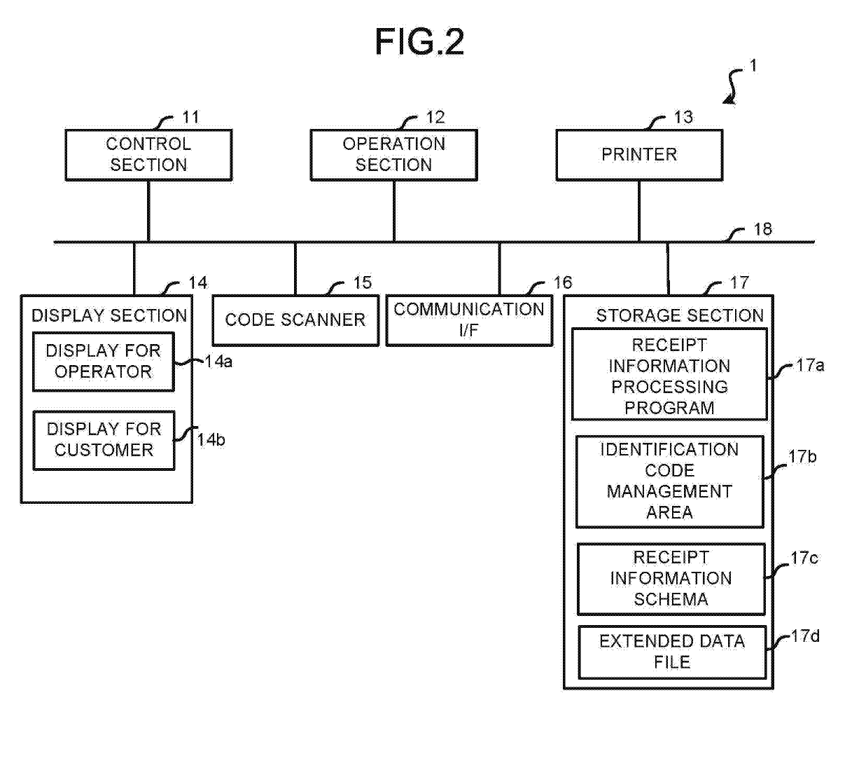

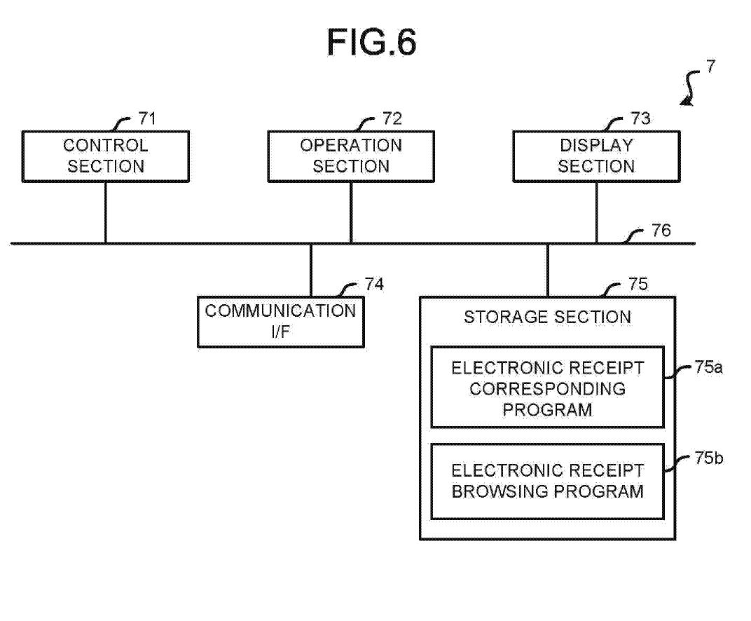

After the forgoing member registration is completed, the portable terminal 7 takes the member code of the customer as the reception destination code and displays it on a display section 73 (refer to FIG. 6) as a code symbol such as a barcode or two-dimensional code. The customer presents the code symbol displayed on the portable terminal 7 to a store clerk when settling a transaction in the store P1. The store clerk reads the code symbol displayed on the portable terminal 7 with a code scanner 15 (refer to FIG. 2) connected with the POS terminal 1. In this way, the electronic receipt information that is generated after a settlement processing of the commodity sales data processing is carried out by the POS terminal 1 is associated with the member code of the customer.

Further, after the POS terminal 1 completes the settlement transaction, the portable terminal 7 receives the electronic receipt information of the transaction sent from the electronic receipt management server 4 through the network N5. The portable terminal 7 sends an inquiry for the electronic receipt information corresponding to the member code to the electronic receipt management server 4 via the network N5. The portable terminal 7 then receives the electronic receipt information corresponding to the member code from the electronic receipt management server 4. Further, the portable terminal 7 displays the received electronic receipt information on the display section 73.

In the electronic receipt system with the foregoing structure, electronic receipt information indicating the content of a transaction (settlement) generated after the execution of a commodity sales data processing by the POS terminal 1 located in the store P1 is transferred to the electronic receipt management server 4 through the electronic receipt server 3 and is published on a Web. By designating a URL, the portable terminal 7 installed with the Web browser can download the electronic receipt information issued on the Web into the portable terminal 7 to browser the electronic receipt information through the Web browser. Further, the user may browse the electronic receipt information by using an application for browsing electronic receipt information that is installed on the portable terminal 7.

Next, the electronic receipt system of the present embodiment is described.

The POS terminal 1 acting as a sales data processing apparatus is described first. FIG. 2 is a block diagram illustrating the structure of the POS terminal 1. As shown in FIG. 2, the POS terminal 1 is provided with a control section 11 for collectively controlling various operations and each section of the POS terminal 1. The control section 11 is a computer with a Central Processing Unit (CPU), a Read Only Memory (ROM) for storing various programs and data, a Random Access Memory (RAM) for storing various programs temporarily or storing various data in a rewritable manner and a Real Time Clock (RTC) section for counting the current date and time.

The control section 11 is connected to an operation section 12, the printer 13, a display section 14 and the code scanner 15 via a bus line 18.

The operation section 12 includes various operation keys for an operator to carry out input operations. The operation keys include, for example, numeric keys for the input of numerical values, cursor keys and selection determination keys for the selection of a specific item, a subtotal key for the output of the subtotal of commodities to which the sales registration in the transaction is carried out, and a closing key for closing one transaction to declare the settlement of prices.

The printer 13 is used to print a receipt, a report and the like. The printer 13 that is equipped with a cutting mechanism (not shown) for cutting off a sheet such as roll paper serving as a print object cuts off the sheet according to a cut instruction described later.

The display section 14 which is, for example, a liquid crystal display, displays various kinds of information including the commodity name and the price of a commodity to which the sales registration is carried out, a total amount and a change amount of a transaction which is settled. The display section 14 comprises a display for operator 14a which displays various kinds of information to a cashier and a display for customer 14b which displays various kinds of information to a customer. Further, the display section 14 maybe a touch panel screen, and in this case, the touch screen functions as the operation section 12.

The code scanner 15 is a scanner device which optically reads a code symbol such as a barcode or a two-dimensional code. The code scanner 15 reads, for example, a code symbol attached to a commodity or a code symbol displayed on the portable terminal 7 and outputs the information retained in the code symbol to the control section 11. Further, a commodity code for specifying a commodity is included in a code symbol attached to the commodity. Further, a member code (customer code) for specifying a customer who carries the portable terminal 7 is contained in a code symbol displayed on the portable terminal 7.

Further, the control section 11 is connected, via the bus line 18, with a communication interface (I/F) 16 through which the control section 11 can be connected with the in-store network N1 and the network N2.

Further, the control section 11 is connected to a storage section 17 via the bus line 18. The storage section 17 is an auxiliary storage device such as a Hard Disk Drive (HDD) or a Solid State Drive (SSD). The storage section 17 stores programs for executing various POS jobs including a commodity sales data processing. Further, the storage section 17 stores various data files relating to a commodity sales data processing, including a point file and a commodity data file in which the commodity data of each commodity—such as the commodity name, the commodity code and the unit price of the commodity—is stored. Further, the storage section 17 stores a receipt information processing program 17a for executing commodity sales data processing or a processing relating to receipt information.

The maximum purchase quantity and the special sale information of each commodity are stored in the commodity data file. Further, the valid date of the points associated with the member code is stored in the point file.

Further, the storage section 17 stores a POS number separately identifying each POS terminal 1 from other POS terminals 1, a company code (the identification code of a company that runs stores), a business category/business style code and a store code indicating the store P1 in which the POS terminal 1 is arranged in the identification code management area 17b thereof. Herein, the business category/business style code is a code (classification code) for distinguishing the business category and business style of a store as, for example, a convenience store, a supermarket, a department store, a pharmacy, a restaurant or an eating house. Further, the business category and business style of a store can be selectively changed according to preference of the user. Further, the company code (the identification code of a company that runs stores) and the business category/business style code may also be registered in the electronic receipt server 3.

Further, the storage section 17 stores a receipt information schema 17c in which a conversion rule for the conversion of receipt information in an unstructured format into electronic receipt information in a structured format is recorded.

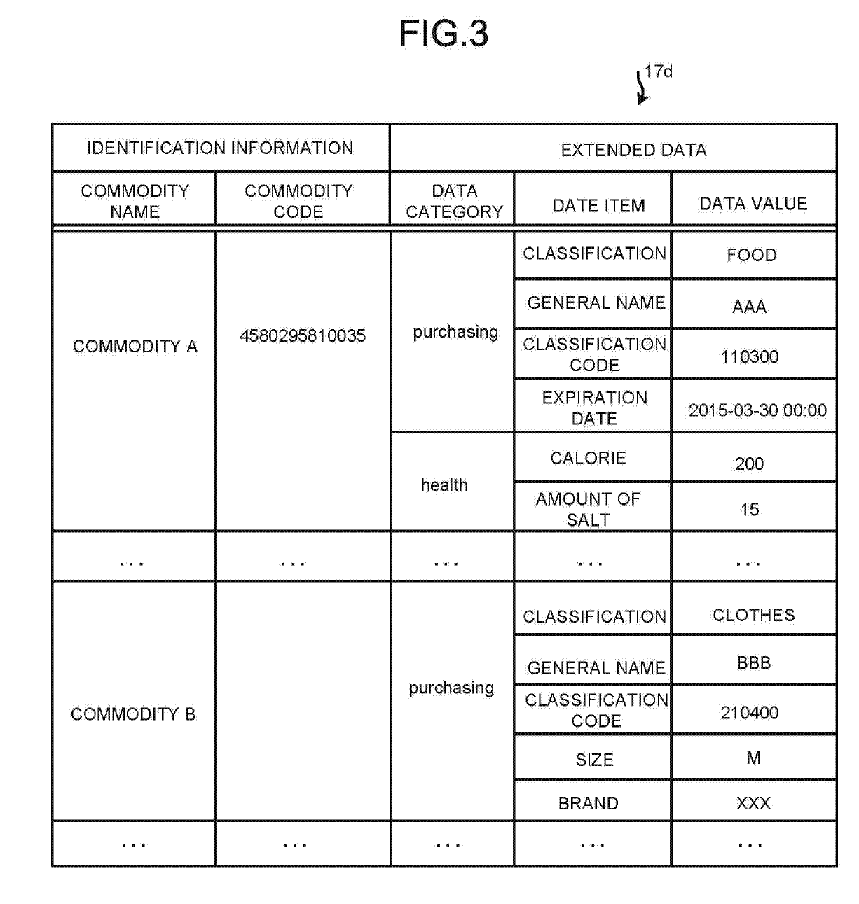

Further, the storage section 17 stores an extended data file 17d, described later, in which extended data relating to each commodity is stored. FIG. 3 is a diagram illustrating the data structure of the extended data file 17d.

As shown in FIG. 3, the extended data file 17d stores the extended data (additional information) relating to a commodity in association with identification information capable of identifying each commodity. The identification information includes, for example, the commodity name and/or the commodity code.

The extended data is a data set including, for example, a data category, data items and data values. The data category corresponds to a classification name when the extended data is classified according to a predetermined standard. Further, in the portable terminal 7 which receives the under-mentioned electronic receipt information (extended data), the data category functions as a classification for designating a range of usable extended data. Further, the data categories are not limited to those named above. The data categories can be selectively named or classified as desired. For example, the data category can be classified according to the features or the purposes of the data items (the data values). Further, the data category may also be classified based on an application that uses the data items (the data values). It is exemplified in FIG. 3 that ‘purchasing’ relating to the details of a commodity and ‘health’ relating to the nutrients included in the commodity are set as the data categories.

Item names of the various kinds of information relating to a commodity are stored in the data items. The data items can be set as desired and are not subject to any particular limitation. It is exemplified in FIG. 3 that data items ‘classification’, ‘general name’, ‘classification code’ and ‘expiration date’ (or consumption date) of a commodity are set for the data category ‘purchasing’ of a commodity A. The classification code, for example, may use a general code system based on a standard such as JICFS. It is also exemplified in FIG. 3 that data items ‘calorie’ and ‘amount of salt’ are set for the data category ‘health’ of the commodity A. It is exemplified in FIG. 3 that data items ‘classification’, ‘general name’, ‘classification code’, ‘size’ and ‘brand’ are set for the data category ‘purchasing’ of a commodity B.

The value of the data corresponding to a data item is stored in the data value. For example, ‘food’ or ‘clothes’ is stored in the data value corresponding to a data item ‘classification’.

The data structure of the extended data file 17d is not limited to the example shown in FIG. 3. For example, an extended data file 17d that deletes the element of the data category from the data structure shown in FIG. 3 maybe used. Further, the data sets of the extended data (data category, data items and data values) may be retained in the extended data file 17d in the under-mentioned unstructured format.

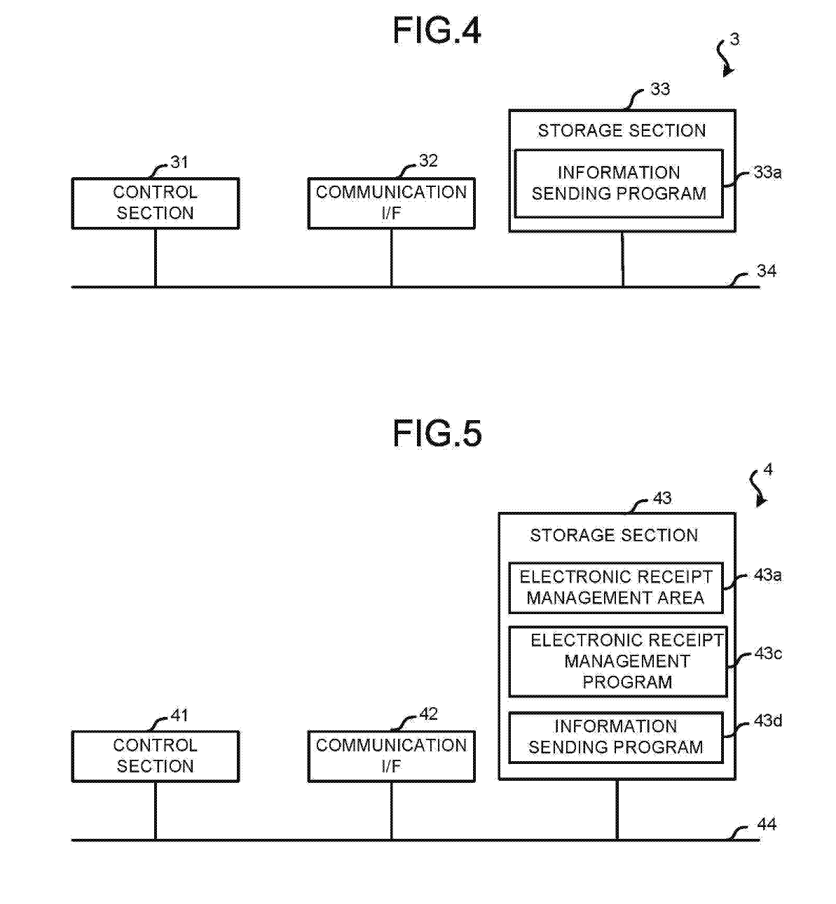

Next, the structure of the electronic receipt server 3 functioning as a receipt management server for company is described below with reference to the block diagram of FIG. 4. FIG. 4 is a block diagram illustrating the structure of the electronic receipt server 3.

As shown in FIG. 4, the electronic receipt server 3 is provided with a control section 31 for collectively controlling various operations and each section of the electronic receipt server 3. The control section 31 is a computer that includes a CPU, a ROM for storing various programs and data, a RAM for storing various programs temporarily or storing various data in a rewritable manner and an RTC section for counting the current date and time.

The control section 31 can be connected with the networks N2 and N3 via a communication I/F 32 connected with a bus line 34. Further, the control section 31 is connected with a storage section 33 via the bus line 34. The storage section 33 stores an information sending program 33a for sending (transmitting) the electronic receipt information sent from the POS terminal 1 to the electronic receipt management server 4.

Sequentially, the structure of the electronic receipt management server 4 functioning as a receipt management server for customer is described below with reference to the block diagram of FIG. 5. FIG. 5 is a block diagram illustrating the structure of the electronic receipt management server 4.

As shown in FIG. 5, the electronic receipt management server 4 is provided with a control section 41 for collectively controlling various operations and each section of the electronic receipt management server 4. The control section 41 is a computer that includes a CPU, a ROM for storing various programs and data, a RAM for storing various programs temporarily or storing various data in a rewritable manner and an RTC section for counting the current date and time.

The control section 41 can be connected with the networks N3 and N5 via a communication I/F 42 connected with a bus line 44. Further, the control section 41 is connected with a storage section 43 via the bus line 44.

In addition to a member master file management area (not shown) for storing and managing the member master file, an electronic receipt management area 43a for collectively storing the electronic receipt information of various companies that run stores is set in the storage section 43. More specifically, the electronic receipt management area 43a manages the electronic receipt information of various companies that run stores for each member.

The electronic receipt information includes a member code, a company code (the identification code of a company that runs stores), a store code, the POS number of the POS terminal 1, a receipt number and commodity sales data (including date and time data). Thus, for example, a consumer goods manufacturer can acquire unique verification information of a purchased commodity relating to the manufacturer according to the electronic receipt information under a certain condition (for example, specific limitations to a company that runs stores, specific limitations to an area and specific limitations to time). Further, the consumer goods manufacturer is the manufacturer of a commodity such as food, beverage, clothes, cosmetic, medicine and household goods.

Further, in addition to a member management program (not shown) for managing the member master file in the member master file management area, the storage section 43 also stores an electronic receipt management program 43c for managing the electronic receipt information of each company in the electronic receipt management area 43a. Further, the storage section 43 stores an information sending program 43d for sending electronic receipt information to the portable terminal 7. Further, the member master file management area and the electronic receipt management area 43a are included in the database DB shown in FIG. 1.

Next, the structure of the portable terminal 7 is described with reference to the block diagram of FIG. 6. Herein, FIG. 6 is a block diagram illustrating the structure of the portable terminal 7.

As shown in FIG. 6, the portable terminal 7 is provided with a control section 71 for collectively controlling various operations and each section of the portable terminal 7. The control section 71 is a computer that includes a CPU, a ROM for storing various programs and data, a RAM for storing various programs temporarily or storing various data in a rewritable manner and an RTC section for counting the current date and time.

The control section 71 is connected with an operation section 72 and a display section 73 via a bus line 76. The operation section 72 includes various operating keys for the user (customer) to carry out an input operation and a pointing device. The display section 73 which is, for example, a liquid crystal panel, displays various kinds of information such as the under-mentioned electronic receipt information. The display section 73 may be a touch screen, and in this case, the touch screen functions as the operation section 72.

The control section 71 is connected, through a bus line 76, with a communication I/F 74 through which the control section 71 is connected with the network N5. The control section 71 may also be connected with the in-store network N1 via the communication I/F 74.

The control section 71 is connected to a storage section 75 via the bus line 76. In addition to a web browser for browsing the various kinds of information (contents) issued on a Web, the storage section 75 also stores an electronic receipt corresponding program 75a for receiving electronic receipt information from the electronic receipt management server 4 and an electronic receipt browsing program 75b for browsing the received electronic receipt information.

Next, the operations carried out by each section of the system of the present embodiment are described below.

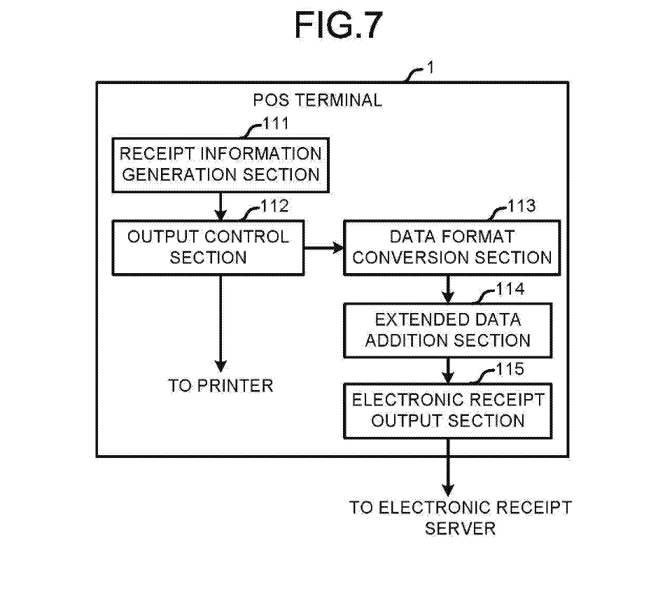

An electronic receipt processing carried out by the operations of the control section 11 of the POS terminal 1 according to the receipt information processing program 17a is described first with reference to FIGS. 7-11.

FIG. 7 is a block diagram illustrating the functional sections of the POS terminal 1 relating to an electronic receipt processing. As shown in FIG. 7, the receipt information processing program 17a executed by the POS terminal 1 has a module structure including a receipt information generation section 111, an output control section 112, a data format conversion section 113, an extended data adding section 114 and an electronic receipt output section 115. By reading out the receipt information processing program 17a from the storage section 17 and executing it by the CPU of the control section 11, the foregoing each functional section is loaded on the RAM to be implemented in actual hardware. In the present embodiment, within the foregoing functional sections, the output control section 112, the data format conversion section 113, the extended data adding section 114 and the electronic receipt output section 115 structurally corresponds to an output control apparatus. The structure is not limited to the above description; for example, the output control apparatus may include the receipt information generation section 111.

The receipt information generation section 111 is a functional section for carrying out a commodity sales data processing and generation of print data of a receipt (receipt information). If a commodity code for specifying a commodity is acquired by the code scanner 15, then the receipt information generation section 111 reads out commodity data corresponding to the commodity code from the commodity data file to carry out a commodity sales data processing to calculate a settlement amount based on the unit price included in the commodity data. The receipt information generation section 111 generates commodity sales data that is processed at the time of a commodity sales data processing. That is, the receipt information generation section 111 generates receipt information containing the transaction content of the commodity.

Further, if a member code for specifying a customer is acquired by the code scanner 15 at any timing during a transaction process, the receipt information generation section 111 generates receipt information containing the member code. In a case of the member code is acquired, the receipt information generation section 111 may generate receipt information containing information (acquisition information) indicating the acquisition of the member code.

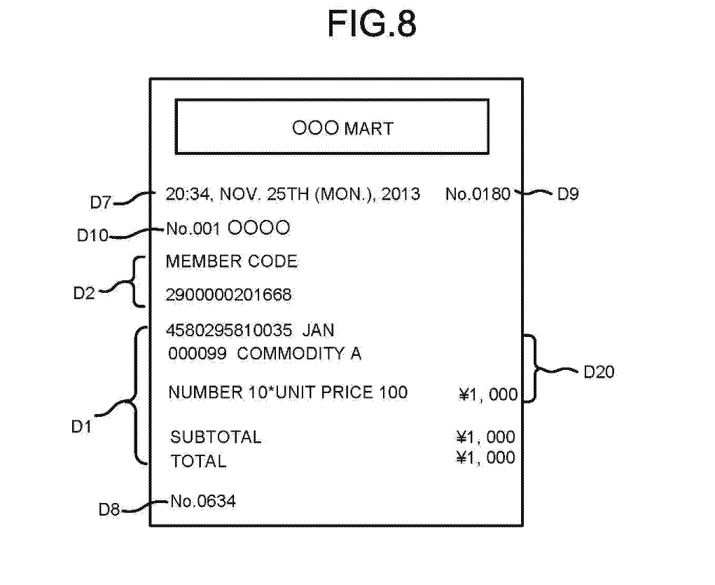

FIG. 8 is a diagram schematically illustrating receipt information. Herein, the receipt information is text data in an unstructured format and used for the printing of the printer 13. As shown in FIG. 8, the receipt information includes the foregoing commodity sales data D1 and elements D2 (acquisition information ‘member code’ and member code ‘2900000201668’) relating to a member code. The commodity sales data D1 includes the commodity name, the commodity code and the amount of each commodity serving as a settlement object, the total amount of each settled commodity, a deposit amount paid by the customer and a change amount. Herein, the information of each settled commodity including the commodity name, the commodity code and the amount is set for each commodity as individual commodity sales data D20.

Further, the receipt information includes transaction date and time D7, a transaction number (receipt number) D8, a register number D9, a name of the person in charge D10 and other elements. Not limited to the elements shown in FIG. 8, other elements, for example, a company code (company name) indicating a company that runs stores, a store code (store name) and the telephone number, the address and the business category/business style code of a store may also be included in the receipt information.

If the ‘closing’ key is pressed, then the receipt information generation section 111 determines that a commodity sales data processing corresponding to a transaction is completed and outputs (issues) the generated receipt information, together with a cut instruction, to the output control section 112. Herein, the cut instruction, one of printer control instructions used generally, is instruction information for instructing the cutting of a sheet on which receipt information is printed. Further, receipt information is collectively generated when the ‘closing’ key is pressed or when the commodity code and the customer code are acquired.

Every time the receipt information generation section 111 generates receipt information corresponding to a transaction, the output control section 112 determines the output destination of the receipt information. More specifically, the output control section 112 determines that the receipt information corresponding to a transaction is generated by the receipt information generation section 111 if the cut command is issued. Further, the output control section 112 determines whether the generated receipt information contains a member code and outputs the receipt information to the output destination determined according to the result of the determination. Further, if acquisition information is contained in the receipt information, then the output control section 112 may determine an output destination according to whether acquisition information or a group of acquisition information and member code is contained.

Specifically, if it is determined that no member code is contained in the receipt information, then the output control section 112 outputs the receipt information and a cut instruction to the printer 13 together so that in the printer 13, a sheet is printed with the receipt information and then cut off according to the cutoff instruction. Thereby a paper receipt corresponding to a transaction is printed. At the time of printing output, all the elements of the receipt information may be printed or the paper receipt maybe printed in a state of removing the member code and the acquisition information and adding other information such as an advertisement.

If it is determined that a member code is contained in the receipt information, then the output control section 112 outputs the receipt information to the data format conversion section 113.

The data format conversion section 113 converts the receipt information input from the output control section 112 into data in a specific data format according to a conversion rule recorded in the receipt information schema 17c. The data format conversion section 113 outputs the receipt information resulting from the conversion of the data format (i.e., electronic receipt information) to the extended data adding section 114.

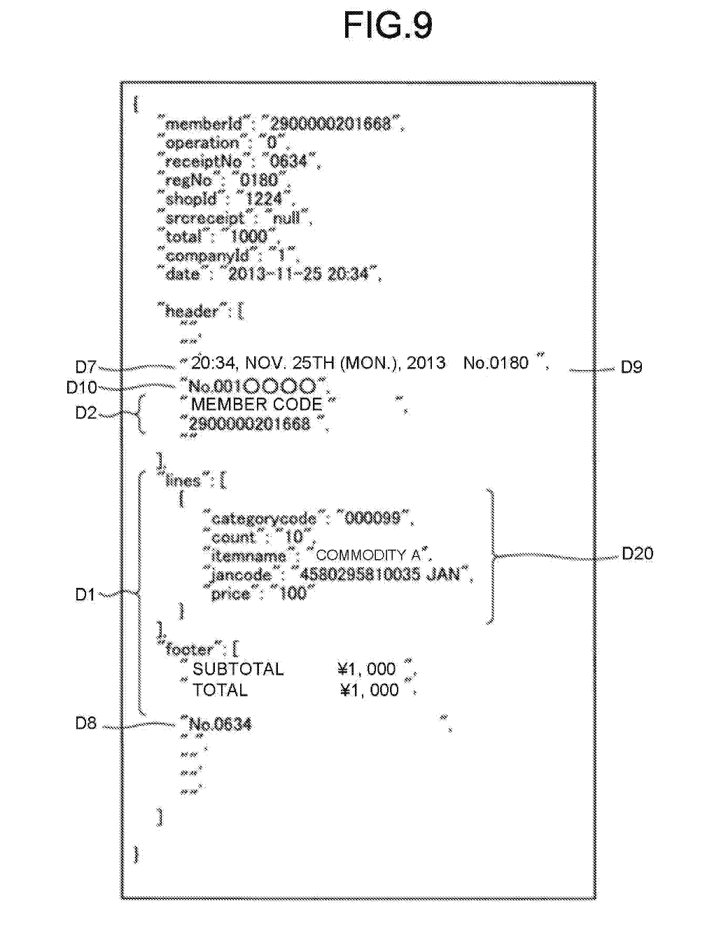

FIG. 9 is a diagram schematically illustrating electronic receipt information. As shown in FIG. 9, electronic receipt information is made up of data (structured files) in a structured format such as XML, CSV and JSON (JavaScript® Object Notation). The conversion of each element (D1-D2, D7-D10, D20) of the receipt information shown in FIG. 8 into data in JSON format is exemplified in FIG. 9. For example, the individual commodity sales data D20 shown in FIG. 8 is converted into structured data shown in FIG. 9 by making each element structured with the use of parenthesis and double quotation.

The conversion of receipt information into electronic receipt information is carried out based on a conversion rule recorded in the receipt information schema 17c. Specifically, specific elements constituting receipt information and attribute information (e.g. mark) indicating attributes of the elements are defined in the receipt information schema 17c. By structuring each element of receipt information with the use of corresponding attribute information, the output control section 112 generates electronic receipt information in a structured format, like that shown in FIG. 9.

Return to FIG. 7, the extended data adding section 114 adds extended data to the electronic receipt information converted by the data format conversion section 113 into data in a structured format. More specifically, the extended data adding section 114 analyzes the structure and content of each element of the electronic receipt information and extracts the identification information of each commodity, for example, the commodity name or the commodity code of each commodity, contained in the commodity sales data D1. Sequentially, by using the extracted identification information of each commodity as a retrieval key, the extended data adding section 114 retrieves extended data corresponding to the retrieval key from the extended data file 17d. Then, the extended data adding section 114 adds (appends) the acquired extended data of each commodity in association with the individual commodity sales data D20 of a corresponding commodity.

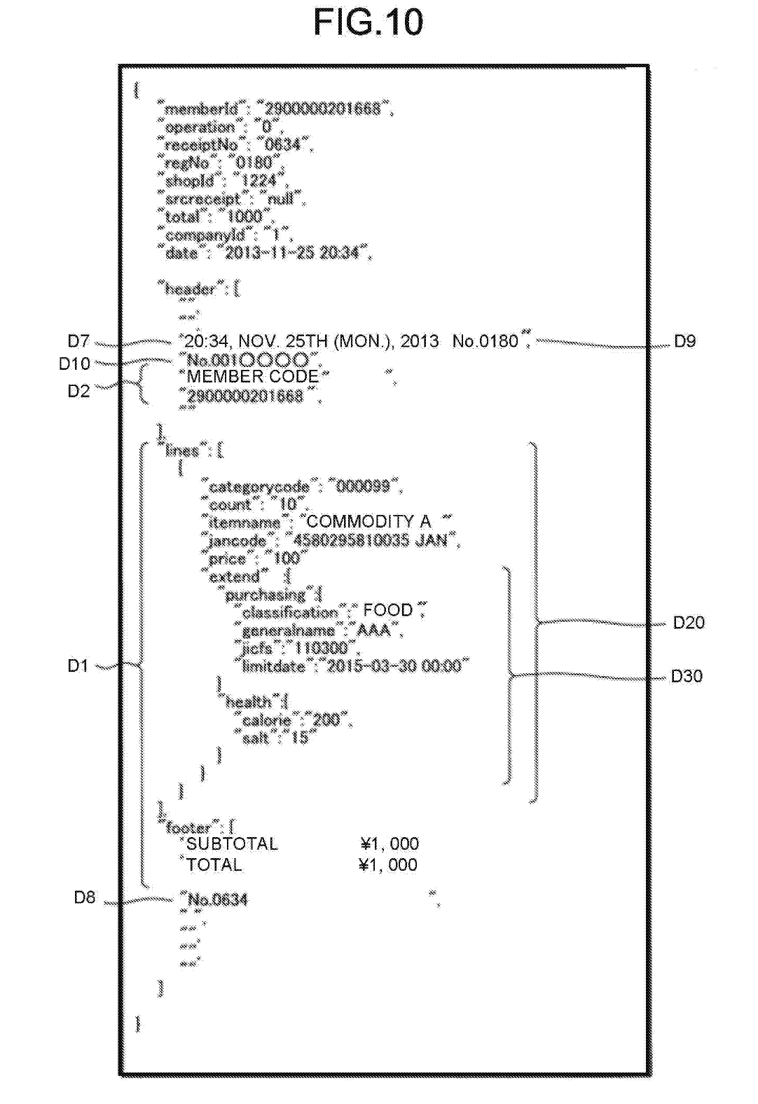

FIG. 10 is a diagram schematically illustrating electronic receipt information added with extended data. Further, the content shown in FIG. 10 corresponds to the electronic receipt information shown in FIG. 9. For example, if the extended data of the “commodity A” is acquired from the extended data file 17d (refer to FIG. 3), then the extended data adding section 114 adds the extended data into the individual commodity sales data D20 of the commodity A as extended data D30. Herein, the extended data D30 is defined by a tag ‘extend’ and recorded in the same structured format with the other elements.

Here, the tags (hereinafter referred to as data category tags) of ‘purchasing’ and ‘health’ contained in the extended data D30 are tags corresponding to the data categories shown in FIG. 3. Sets of data item such as ‘classification’, ‘general name’ and ‘calorie’ and a data value are recorded in the data category tag in a structured format. Further, it is exemplified in FIG. 10 that the extended data D30 is defined by a tag ‘extend’; however, the definition of the extended data D30 is not limited to this. Furthermore, the extended data D30 is not limited to be noted as the example shown in FIG. 10.

Return to FIG. 7, the electronic receipt output section 115 sends the electronic receipt information added with the extended data by the extended data adding section 114 to the electronic receipt server 3 managed by a company corresponding to a company code.

In this way, in the POS terminal 1 (output control apparatus), receipt information for printing is converted into data in a structured format, and the electronic receipt information resulting from the conversion processing is added with extended data relating to each commodity serving as the transaction object and then transmitted to an external device. In this way, electronic receipt information which is in a structured format and in which other contents, besides those printed on a paper receipt (receipt information to be printed on the paper), are contained can be processed by the software of the external device. Thus, in the software of the external device, each element contained in the electronic receipt information can be effectively used and various advantages of data management are obtained.

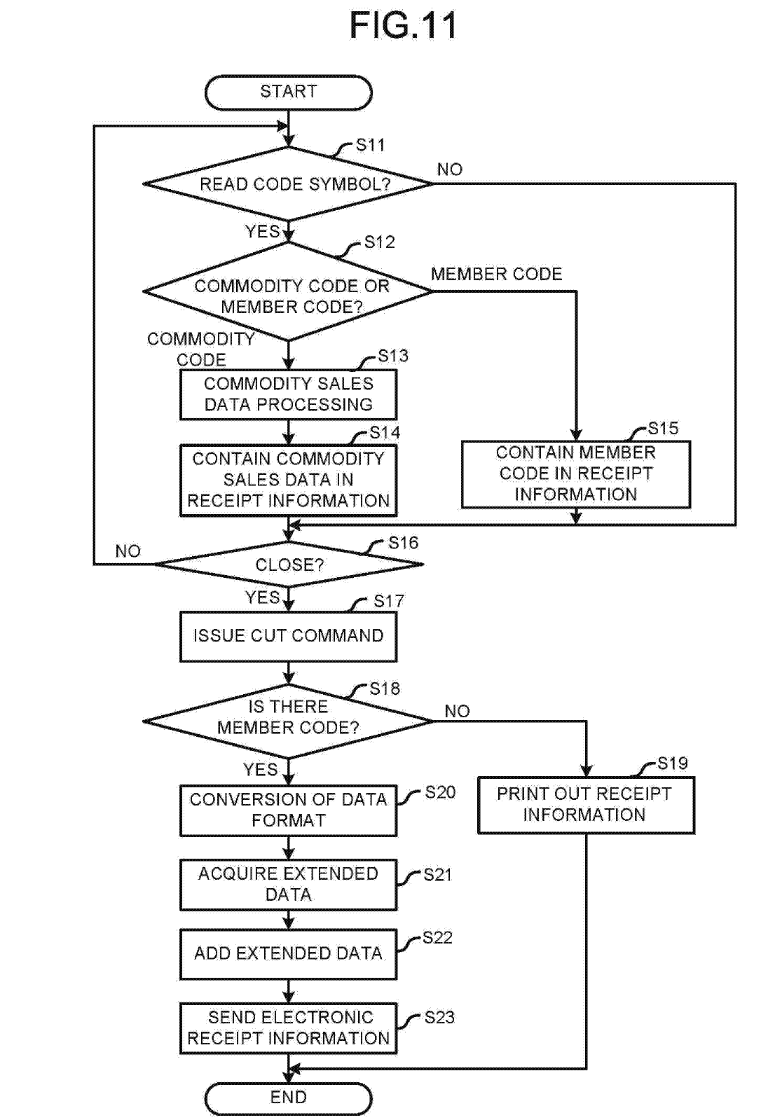

FIG. 11 is a flowchart illustrating the procedures of an electronic receipt processing carried out by the POS terminal 1. First, the receipt information generation section 111 of the POS terminal 1 determines whether the commodity code attached to a commodity or the member code displayed on the portable terminal 7 is read by the code scanner 15 (Act S11). If no code symbol is read (Act S11: No), the receipt information generation section 111 proceeds to Act S16.

On the other hand, if it is determined that a code symbol is read (Act S11: Yes), then the receipt information generation section 111 determines whether the information read through the reading process is a commodity code or a member code (Act S12).

In a case in which a commodity code is acquired in Act S12 (Act S12: commodity code), if the commodity data of a commodity specified by the commodity code is read out from the commodity data file, then the receipt information generation section 111 carries out a commodity sales data processing to calculate a settlement amount according to the unit price contained in the commodity data (Act S13). Next, the receipt information generation section 111 generates receipt information containing the commodity sales data processed during the commodity sales data processing (Act S14).

Further, if a member code is acquired in Act S12 (Act S12: member code), then the receipt information generation section 111 generates receipt information containing the member code (Act S15). Further, the generated receipt information may contain acquisition information indicating the acquisition of a member code in Act S15.

In order to input a member code into the POS terminal 1, for example, a customer who is a member displays a code symbol containing a member code on the display section 73 of the portable terminal 7, then a store clerk or the customer who is a member reads the code symbol with the use of the code scanner 15 of the POS terminal 1 by himself/herself. Further, the receipt information generation section 111 may perform processing to uniquely identify the member code input during one transaction.

In the following Act S16, the receipt information generation section 111 determines whether the ‘closing’ key is pressed to give an instruction for starting a closing processing (Act S16). If no instruction for starting a closing processing is given (Act S16: No), the flow returns to Act S11. If an instruction for starting a closing processing is given (Act S16: Yes), the receipt information generation section 111 issues (outputs) a cut instruction to the output control section 112 (Act S17).

After receiving the cut instruction from the receipt information generation section 111, the output control section 112 determines that receipt information corresponding to a transaction is generated and determines whether a member code is contained in the receipt information (Act S18). Further, if acquisition information is contained in the receipt information, then it maybe determined in Act S18 whether acquisition information or a group of acquisition information and member code is contained in the receipt information.

If no member code is contained in the receipt information (Act S18: No), the output control section 112 outputs the receipt information of the transaction, together with the cut instruction, to the printer 13 to print out the receipt information (Act S19), and then the processing is ended. Sequentially, in the printer 13, the receipt information is printed on a sheet, and later the sheet is cut off according to the cut instruction, thereby printing out a paper receipt corresponding to a transaction.

On the other hand, if a member code is contained in the receipt information (Act S18: Yes), then the output control section 112 outputs the receipt information to the data format conversion section 113. The data format conversion section 113 converts the data format of the receipt information from an unstructured format into a structured format to generate electronic receipt information (Act S20).

Next, if the identification information of each commodity is extracted from the electronic receipt information generated in Act S20, then the extended data adding section 114 acquires extended data corresponding to the identification information from the extended data file 17d (Act S21). Then, the extended data adding section 114 adds the acquired extended data to the electronic receipt information (Act S22).

Then, the electronic receipt output section 115 sends the electronic receipt information added with the extended data in Act S22 to the electronic receipt server 3 via the communication I/F 16 (Act S23), and the present processing is ended. The electronic receipt information sent to the electronic receipt server 3 is transferred to the electronic receipt management server 4 from the electronic receipt server 3.

Further, it is described above that receipt information is output to the electronic receipt server 3 in a case where the receipt information contains a member code. However, the processing is not limited to this. For example, receipt information containing a member code may also be output to both the printer 13 and the electronic receipt server 3.

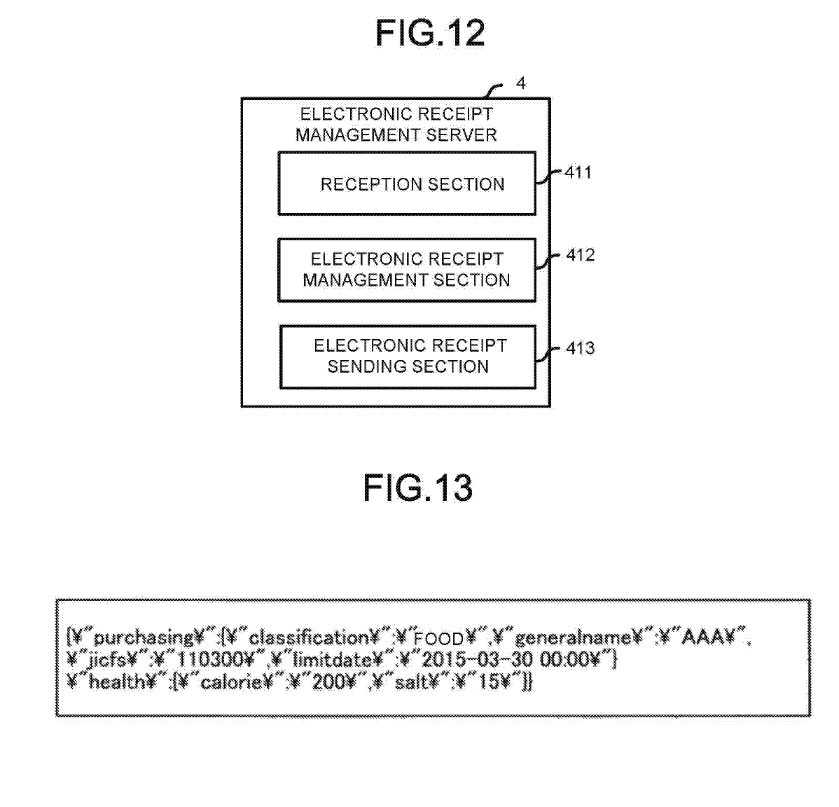

The flow of an electronic receipt management processing carried out by the operation of the control section 41 of the electronic receipt management server 4 according to the electronic receipt management program 43c and that of an information sending processing carried out by the operation of the control section 41 of the electronic receipt management server 4 according to the information sending program 43d are described below with reference to FIGS. 12-14.

FIG. 12 is a block diagram illustrating the functional sections of the electronic receipt management server 4 relating to an electronic receipt management processing and an information sending processing. As shown in FIG. 12, the electronic receipt management program 43c and the information sending program 43d executed by the electronic receipt management server 4 have a module structure including a receiving section 411, an electronic receipt management section 412 and an electronic receipt sending section 413. By reading out the electronic receipt management program 43c and the information sending program 43d from the storage section 43 and executing them with the CPU of the control section 41, foregoing each section is loaded on the RAM. In this manner, the reception section 411, the electronic receipt management section 412 and the electronic receipt sending section 413 are implemented in actual hardware.

Instead of receiving a receipt or an voucher which is printed and issued during a commodity sales data processing, the receiving section 411 receives, from the electronic receipt server 3, the electronically processed electronic receipt information of a company unit in which a company code indicating a company that runs stores is contained.

The electronic receipt management section 412 stores the electronic receipt information of a company unit received by the receiving section 411 in the electronic receipt management area 43a of the storage section 43 and manages it. After converting the format of the extended data contained in the electronic receipt information into an unstructured format, the electronic receipt management section 412 stores the electronic receipt information in the electronic receipt management area 43a.

Specifically, the electronic receipt management section 412 detects the extended data D30 (extend tag) from the individual commodity sales data D20 of each commodity contained in the commodity sales data D1. Then, the electronic receipt management section 412 converts the extracted extended data D30 into data in an unstructured format.

FIG. 13 is a diagram schematically illustrating extended data in an unstructured format. In FIG. 13, the elements in the extend tag shown in FIG. 10 are partially converted into data in an unstructured format. For example, in JSON format, double quotation marks (“) are used to define an element name (an attribute name), and thus, double quotation marks have a special meaning which is different from other character strings. Thus, as shown in FIG. 13, the electronic receipt management section 412 adds an escape character (¥) in front of the double quotation marks (“) contained in extended data to convert the format of the extended data into an unstructured format so that the extended data can be processed in the same way as other character strings.

Here, predetermined elements are contained in the electronic receipt information not added with extended data, as shown in FIGS. 8 and 9. Thus, by storing the predetermined elements in the electronic receipt information not added with extended data as data items, data can be managed easily and effectively. However, as stated above, the data (data category, data item and data value) contained in extended data can be selectively set. Thus, in a case where the elements contained in extended data are managed at a unit of data category or data item, no storage areas are prepared in advance for these units in the electronic receipt management area 43a. Moreover, in this case, a processing like preparing storage areas for these units in the electronic receipt management area 43a occurs, and thus, data management may be complicated.

Thus, in the electronic receipt management section 412, each element included in the extend tag is converted into data in an unstructured format, as described above, so that the resulting data can be stored and managed as an element (text data). In this way, the electronic receipt management section 412 can store and manage the extended data easily.

Further, the data structure of the unstructured extended data stored in the electronic receipt management area 43a is not limited to the above description. For example, the electronic receipt management section 412 prepares a data item of the individual commodity sales data D20 and a data item corresponding to the extend tag that are associated with each other in the electronic receipt management area 43a. Then, the electronic receipt management section 412 stores the individual commodity sales data D20 of each commodity and unstructured extended data of a corresponding commodity that are associated with each other as two separate data items.

Further, only the extended data part contained in electronic receipt information is converted into data in an unstructured format in the present embodiment; however, the present invention is not limited to this. For example, the electronic receipt management section 412 may convert the whole electronic receipt information into data in an unstructured format and then store and manage the data in an unstructured format in the electronic receipt management area 43a. Further, the electronic receipt management section 412 may convert all the elements of electronic receipt information except for a member code or a company code into data in an unstructured format and then store and manage the data in an unstructured format in the electronic receipt management area 43a.

The electronic receipt sending section 413 acquires the electronic receipt information which corresponds to the member code and in which at least one or more company codes are contained from the electronic receipt management area 43a and sends the acquired electronic receipt information to the portable terminal 7 associated with the member code of a specific customer.

If the electronic receipt information is acquired from the electronic receipt management area 43a, the electronic receipt sending section 413 converts the extended data contained in the electronic receipt information into a structured format. Then, the electronic receipt sending section 413 sends the converted electronic receipt information to the portable terminal 7. In this way, the electronic receipt information in a structured format can be browsed in the portable terminal 7. Thus, the elements contained in the electronic receipt information can be used effectively.

Further, the conversion of the extended data from an unstructured format into a structured format executed by the electronic receipt sending section 413 can be realized by carrying out a conversion processing that is reverse to the conversion from a structured format into an unstructured format executed by the electronic receipt management section 412. For example, the electronic receipt sending section 413 converts the extended data in an unstructured format shown in FIG. 13 into data in structured format by deleting the escape character (¥) added in front of double quotation marks (“).

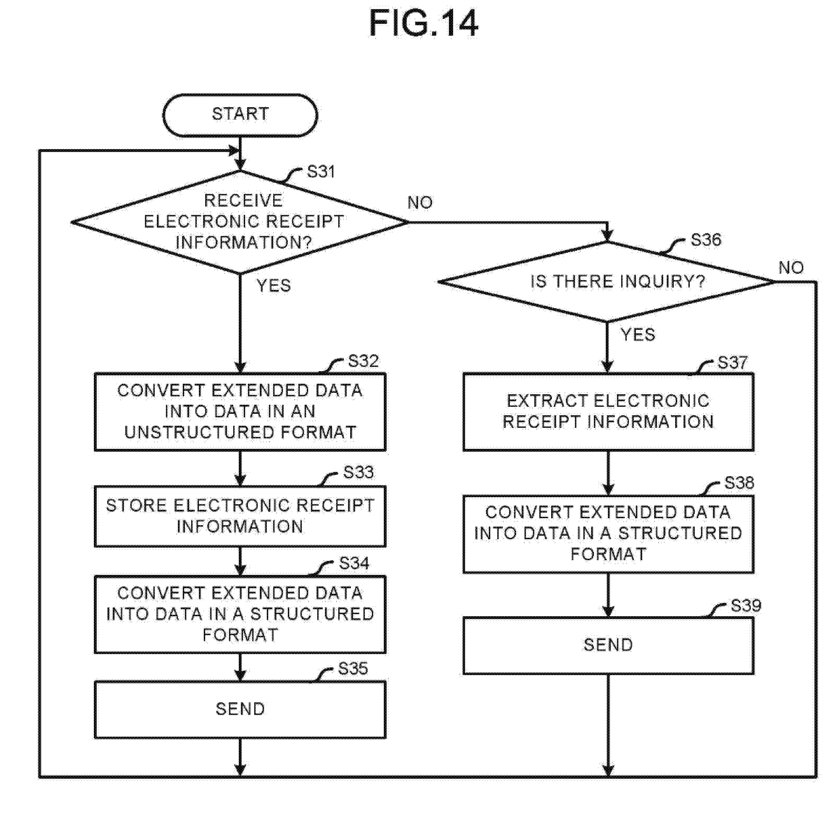

FIG. 14 is a flowchart illustrating the procedures of an electronic receipt management processing and an information sending processing carried out by the electronic receipt management server 4. First, the receiving section 411 determines whether the electronic receipt information sent from the electronic receipt server 3 of each company is received via the communication I/F 42 (S31).

If the electronic receipt information is received (Act S31: Yes), the electronic receipt management section 412 converts the extended data contained in the electronic receipt information into data in an unstructured format (Act S32). Sequentially, the electronic receipt management section 412 stores the electronic receipt information resulting from the conversion processing in Act S32 in the electronic receipt management area 43a of the storage section 43 (Act S33).

Then, the electronic receipt sending section 413 reads out the electronic receipt information stored in Act S33 from the electronic receipt management area 43a. Next, the electronic receipt sending section 413 converts the extended data contained in the electronic receipt information into a structured format (Act S34). Then, the electronic receipt sending section 413 sends the converted electronic receipt information to a sending destination (portable terminal 7) which is managed in association with the member code contained in the electronic receipt information (Act S35). The flow then returns to Act S31.

It is also applicable the electronic receipt information, after received, is sent to the portable terminal 7 immediately by the electronic receipt sending section 413. That is, the electronic receipt information containing extended data which is not converted into the unstructured format is sent.

the electronic receipt information from the portable terminal 7 (Act S31: No→Act S36: Yes), the electronic receipt sending section 413 extracts the electronic receipt information stored and managed in the electronic receipt management area 43a according to the content of the inquiry of the electronic receipt information (Act S37). Then, the electronic receipt sending section 413 converts the extended data contained in the extracted electronic receipt information into data in a structured format (Act S38). The electronic receipt sending section 413 sends the converted electronic receipt information to the requesting portable terminal 7 (Act S39), and then the flow returns to Act S31. Further, if no electronic receipt information is received and there is no request for the electronic receipt information (Act S31: No→Act S36: No), the electronic receipt management server 4 returns to Act S31 to enter a standby state until electronic receipt information is received or there is a request for the electronic receipt information.

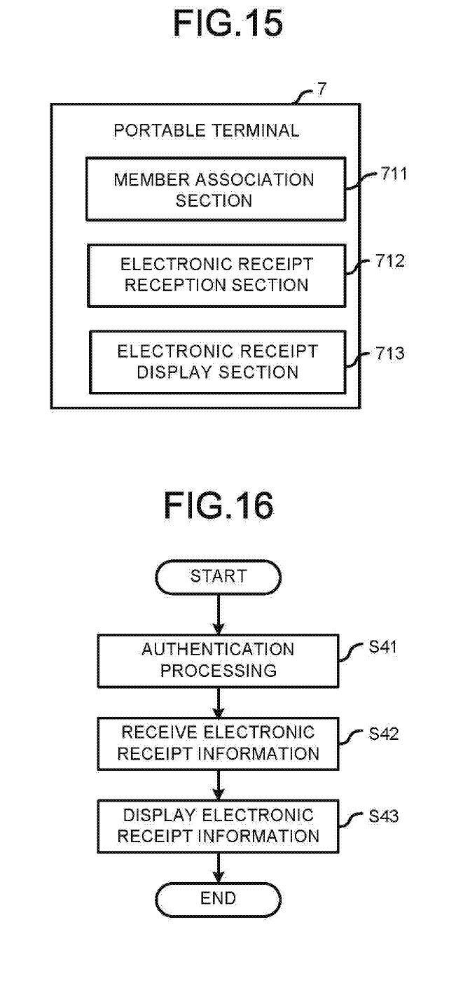

Next, the flow of an electronic receipt receiving processing carried out by the operations of the control section 71 of the portable terminal 7 according to the electronic receipt corresponding program 75a and that of an electronic receipt browsing processing carried out by the operations of the control section 71 of the portable terminal 7 according to the electronic receipt browsing program 75b is described below with reference to FIGS. 15-17.

FIG. 15 is a block diagram illustrating the functional sections of the POS terminal 7 relating to an electronic receipt receiving processing and an electronic receipt browsing processing. As shown in FIG. 15, the electronic receipt corresponding program 75a and the electronic receipt browsing program 75b executed by the portable terminal 7 have a module structure including a member association section 711, an electronic receipt receiving section 712 and an electronic receipt display section 713. By reading out the electronic receipt corresponding program 75a and the electronic receipt browsing program 75b from the storage section 75 and executing them with the CPU of the control section 71, each section is loaded on the RAM. In this manner, the member association section 711, the electronic receipt receiving section 712 and the electronic receipt display section 713 are implemented in actual hardware.

The member association section 711 associates the member code of a specific customer with a portable terminal. The electronic receipt receiving section 712 receives electronic receipt information from the electronic receipt management server 4. The electronic receipt display section 713 displays the electronic receipt information received by the electronic receipt receiving section 712 on the display section 73.

FIG. 16 is a flowchart illustrating the procedures of an electronic receipt receiving processing and an electronic receipt browsing processing carried out by the portable terminal 7. As shown in FIG. 16, first, the member association section 711 of the portable terminal 7 accesses the electronic receipt management server 4 to input a member code and a password to carryout an authentication processing (Act S41). In this way, an associated relationship is established between the portable terminal 7 and the member code of a specific customer.

After the authentication processing, the electronic receipt receiving section 712 of the portable terminal 7 receives the electronic receipt information, corresponding to the input member code, which is stored and managed in the electronic receipt management area 43a of the electronic receipt management server 4 (Act S42). Further, the electronic receipt information may also be received by email.

Next, the electronic receipt display section 713 of the portable terminal 7 displays the electronic receipt information received by the electronic receipt receiving section 712 on the display section 73 (Act S43), and then the processing is ended.

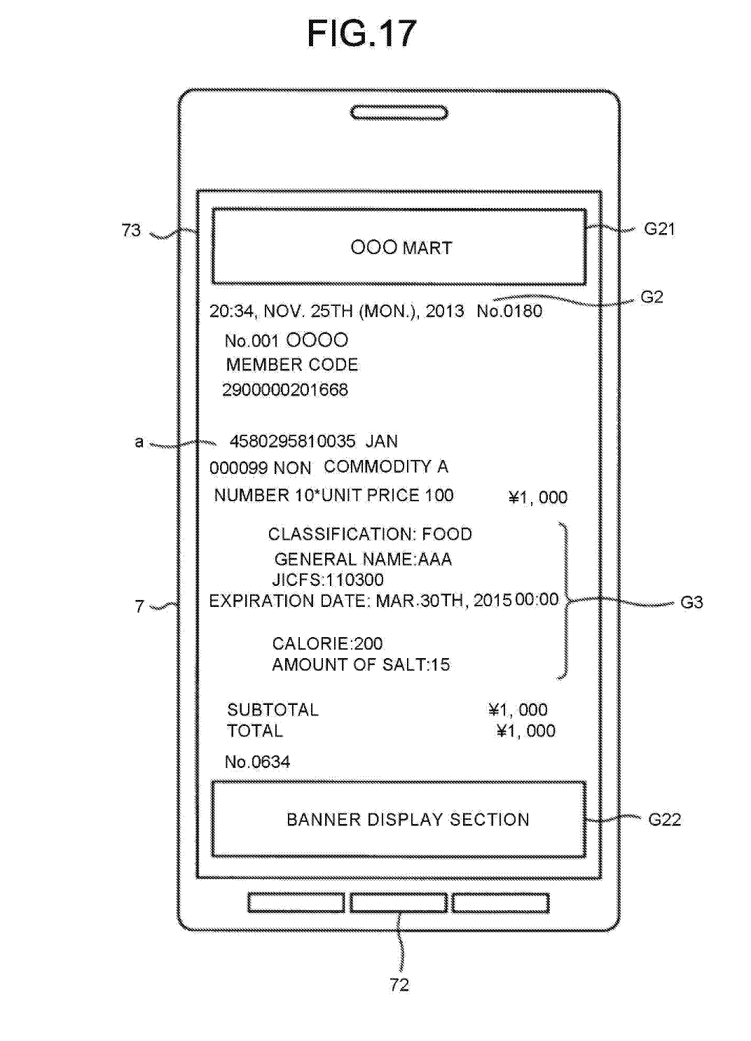

FIG. 17 is a diagram illustrating electronic receipt information G2 displayed on the display section 73 of the portable terminal 7. The electronic receipt information G2 is identical to a paper receipt in layout and content. Further, it is exemplified in FIG. 17 that a store name logo section G21 in which the logo of a store name is displayed and a banner display section G22 in which an advertisement is displayed are included in the electronic receipt information G2. In addition, in the present embodiment, extended data which is not included in a paper receipt is added to the electronic receipt information G2. Thus, each element G3 contained in extended data is displayed on the display section 73.

The electronic receipt display section 713 may display all or part of the elements contained in the extended data on the display section 73. Specifically, the electronic receipt display section 713 may display the elements contained in a specific data category tag (e.g. the ‘purchasing’ shown in FIG. 10) according to the data category tags contained in the extended data.

By entering input using the operation section 72, the user (customer) of the portable terminal 7 can focus attention on a commodity a (indicating a transacted commodity) in the electronic receipt information G2. For example, the electronic receipt display section 713 may display the extended data of the commodity the commodity a is selected through a user operation.

Further, in a case in which a plurality of electronic receipt information is received, a selection screen may be displayed in which each electronic receipt information is displayed to be selected according to the purchase date and the company code contained in the electronic receipt information. In this case, the electronic receipt display section 713 displays the electronic receipt information selected from the selection screen on the display section 73.

Further, the member association section 711, the electronic receipt receiving section 712 and the electronic receipt display section 713 may be realized according to one or more applications (software). The applications may include, for example, an application for household account book management and an application for health management. In this case, the electronic receipt display section 713 realized by each application may display the elements contained in a specific data category tag according to the data category tag contained in the extended data.

For example, the elements contained in the data category tag ‘purchasing’ maybe displayed on the display section 73 through the electronic receipt display section 713 realized by the application for household account book management. Likewise, the elements contained in the data category tag ‘health’ may be displayed on the display section 73 through the electronic receipt display section 713 realized by the application for health management. In these cases, the screen displayed by the electronic receipt display section 713 is preferably a screen corresponding to the feature of each application but is not limited to the screen shown in FIG. 17. For example, through the electronic receipt display section 713 realized by the application for household account book management, the total payment amount of each classification of commodities can be calculated and displayed. Further, through the electronic receipt display section 713 realized by the application for health management, the total calories of each commodity can be calculated and displayed.

In the present embodiment, extended data—the classification of which is set by data category—is added to electronic receipt information and then sent to the portable terminal 7. Thus, electronic receipt information which is in a structured format and which includes other contents different from those printed on a paper receipt (receipt information) can be processed through the software of the portable terminal 7. As a result, through the software of the portable terminal 7, each element contained in the electronic receipt information can be effectively used. This various advantages are achieved in data processing.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is described in the foregoing embodiment that the extended data file 17d is retained in the POS terminal 1; however, the present invention is not limited to this. For example, the extended data file 17d may also be retained in an external device such as the store server 2 or the electronic receipt server 3, and in this case, the POS terminal 1 accesses the extended data file 17d or conducts a retrieval operation in the extended data file 17d.

Further, in the foregoing embodiment, the control section (the data format conversion section 113) of the POS terminal 1 converts receipt information into electronic receipt information; however, the present invention is not limited to this. For example, receipt information may be converted into electronic receipt information by the printer 13 of the POS terminal 1. Specifically, a print control device (not shown) equipped in the printer 13 that controls a printing operation functions as the output control section 112, the data format conversion section 113, the extended data adding section 114 and the electronic receipt output section 115. In this case, if it is determined that no member code is contained in the receipt information generated and input by the control section 11 (receipt information generation section 111) of the POS terminal 1, the print control device of the printer 13 prints out the receipt information. On the other hand, if it is determined that a member code is contained in the receipt information generated and input by the control section 11 (receipt information generation section 111) of the POS terminal 1, the print control device of the printer 13 converts the receipt information into electronic receipt information and also adds (appends) extended data to the electronic receipt information. Then, the print control device of the printer 13 sends the generated electronic receipt information to the electronic receipt server 3 via the communication I/F 16 of the POS terminal 1.

Further, in the foregoing embodiment, extended data is added to electronic receipt information by the control section 11 (the extended data adding section 114) of the POS terminal 1; however, the same operation may also be carried out by another device. For example, extended data may be added to electronic receipt information by the electronic receipt server 3 or the electronic receipt management server 4. Specifically, in the POS terminal 1, the electronic receipt output section 115 sends the electronic receipt information generated by the data format conversion section 113 to the electronic receipt server 3. On the other hand, the control section of the electronic receipt server 3 or the electronic receipt management server 4 functions as the extended data adding section 114 to add extended data to the received electronic receipt information. Further, as a further modification of the embodiment, after the extended data adding section 114 of the POS terminal 1 adds extended data to electronic receipt information, the extended data adding section 114 of the electronic receipt server 3 or the electronic receipt management server 4 adds other extended data different from that added by the extended data adding section 114 of the POS terminal 1.

Further, in the foregoing embodiment, electronic receipt information is stored and managed by the electronic receipt management server 4; however, the present invention is not limited to this. For example, the electronic receipt information sent from the POS terminal 1 may be stored and managed by the electronic receipt server 3. Specifically, the control section 31 of the electronic receipt server 3 functions as the electronic receipt management section 412 or the electronic receipt sending section 413. In this case, if electronic receipt information is received from the POS terminal 1, then the control section 31 of the electronic receipt server 3 converts extended data part into data in an unstructured format and then stores the data in an unstructured format in the storage section 33 to be managed. Further, if the electronic receipt information stored in the storage section 33 is read out at a preset sending timing, the control section 31 of the electronic receipt server 3 converts extended data part into data in a structured format and sends the converted extended data to the electronic receipt management server 4. Further, electronic receipt information containing extended data in an unstructured format may be sent to the electronic receipt management server 4 by the control section 31 of the electronic receipt server 3. In this case, the electronic receipt information sent from the electronic receipt server 3 is stored by the control section 41 (electronic receipt management section 412) of the electronic receipt management server 4 in the electronic receipt management area 43a as it is.

Further, in the foregoing embodiment, a member code is acquired with the use of the code scanner 15; however, the present invention is not limited to this, and a member code may also be acquired in another way. For example, the POS terminal 1 and the portable terminal 7 may be both provided with a near-field wireless communication section such as a Near Field Communication (NFC) or Bluetooth® to transmit/receive a member code through near-field wireless communication. In this case, the portable terminal 7 stores a member code in the storage section 75 or an IC tag (not shown).

Further, in the foregoing embodiment, a member code is acquired from the portable terminal 7; however, the present invention is not limited to this. For example, a member code may also be acquired from a medium such as an IC card or a magnetic card capable of storing a member code. In the use of an IC card, the POS terminal 1 is provided with a reading/writing section such as an IC card reader/writer. In the use of a magnetic card, the POS terminal 1 is provided with a magnetic car reader/writer.

It is described in the foregoing embodiment that each POS terminal 1 sends electronic receipt information to the electronic receipt server 3; however, the present invention is not limited to this. For example, the electronic receipt information generated by the POS terminal 1 in the store P1 may be collected by the store server 2 and then sent to the electronic receipt server 3 by the store server 2. Besides, electronic receipt information may also be directly sent from the electronic receipt management server 4 from the POS terminal 1.

Further, in the foregoing embodiments, electronic receipt information is received by the portable terminal 7 via the electronic receipt management server 4; however, the present invention is not limited to this. For example, electronic receipt information may be directly received by the portable terminal 7 from the POS terminal 1. In this case, the POS terminal 1 outputs the generated electronic receipt information to the portable terminal 7 which is connected with the POS terminal 1 via the in-store network N1 or a near-field wireless communication section (not shown). In this case, an authentication processing may be carried out in the POS terminal 1.

The programs executed by each apparatus of the foregoing embodiment are incorporated into a storage medium (e.g. the ROM or the storage section) of each apparatus in advance; however, the present invention is not limited to this. The programs may be recorded in a computer-readable recording medium such as a CD-ROM, a FD (Flexible Disk), a CD-R, a DVD (Digital Versatile Disk) in the form of installable or executable file to be provided. Further, the storage medium is not limited to be a medium independent from a computer or an incorporated system. For example, the storage medium may also be a storage medium which stores or temporarily stores the downloaded program transmitted via an LAN or the Internet.

Alternatively, the programs executed by each apparatus of the foregoing embodiment may be provided or distributed by a network such as the Internet.

What is claimed is:

1. A point of sale apparatus comprising:
a scanner configured to scan a code on a commodity;
a communication interface; and
a processor configured to control the scanner and communication interface to:
retrieve commodity data based on the scanned code, the commodity data including a name and a price of the commodity,
generate a first receipt information based at least on the retrieved commodity data,
transmit the first receipt information to a printer for printing a paper receipt that includes the name and price of the commodity,
convert the first receipt information to a second receipt information having a different format from the first receipt information,
retrieve classification data corresponding to the commodity based on the second receipt information, the classification data including data not included in the first receipt information, and
transmit, to a storage unit, the classification data in correspondence with the second receipt information.

2. The point of sale apparatus according to claim 1, further comprising:
an interface configured to receive a user identification

3. The point of sale apparatus according to claim 2, wherein the controller is further configured to:
determine whether the user identification is received, and
if the user identification is received, transmit, to the storage unit, the user identification in correspondence with the classification information.

4. The point of sale apparatus according to claim 3, wherein, if the user identification is not received, the controller does not convert the first receipt information to the second receipt information.

5. The point of sale apparatus according to claim 4, wherein, if the user identification is received, the controller controls the interface to transmit the second receipt information to an external device via a network.

6. The point of sale apparatus according to claim 3, wherein the controller determines whether the user identification is received by determining whether the user identification is included in the first receipt information.

7. The point of sale apparatus according to claim 1, wherein the commodity data is retrieved from a first server and the classification data is retrieved from a second server different from the first server.

8. A method of processing commodity information in a point of sale apparatus that includes a scanner, a communication interface, a printer, and a processor, the method comprising the steps of:
scanning a code on a commodity with the scanner;
retrieving, through the communication interface, commodity data based on the scanned code, the commodity data including a name and a price of the commodity;
generating, with the processor, a first receipt information based at least on the retrieved commodity data;
printing, with the printer, a paper receipt that includes the name and price of the commodity;
converting, with the processor, the first receipt information to a second receipt information having a different format from the first receipt information;
retrieving, through the communication interface, classification data corresponding to the commodity based on the second receipt information, the classification data including data not included in the first receipt information; and
transmitting, to a storage unit, the classification data in correspondence with the second receipt information.

9. The method according to claim 8, wherein the point of sale apparatus further includes an interface for receiving a user identification, the method further comprising the steps of:
determining whether the user identification is received; and
if the user identification is received, transmitting, to the storage unit, the user identification in correspondence with the classification information.

10. The method according to claim 9, the method further comprising the step of:
if the user identification is received, transmitting, with the communication interface, the second receipt information to the storage device over a network.

11. The method according to claim 9, wherein whether the user identification is received is determined by determining whether the user identification is included in the first receipt information.

12. The method according to claim 8, wherein the commodity data is retrieved from a first server and the classification data is retrieved from a second server different from the first server.

13. The method according to claim 12, wherein the storage unit in which the classification data is caused to be stored in correspondence with the second receipt information is in the second server.

14. A non-transitory computer readable medium storing instructions causing a point of sale apparatus that includes a scanner, a communication interface, a printer, and a processor to perform a method of processing commodity information, the method comprising the steps of:
scanning a code on a commodity with the scanner;
retrieving, through the communication interface, commodity data based on the scanned code, the commodity data including a name and a price of the commodity;
generating, with the processor, a first receipt information based at least on the retrieved commodity data;
printing, with the printer, a paper receipt that includes the name and price of the commodity;
converting, with the processor, the first receipt information to a second receipt information having a different format from the first receipt information;
retrieving, through the communication interface, classification data corresponding to the commodity based on the second receipt information, the classification data including data not included in the first receipt information; and
transmitting, to a storage unit, the classification data in correspondence with the second receipt information.

15. The non-transitory computer readable medium according to claim 14, wherein the point of sale apparatus further includes an interface for receiving a user identification, the method further comprising the steps of:
determining whether the user identification is received; and
if the user identification is received, transmitting, to the storage unit, the user identification in correspondence with the classification information.

16. The non-transitory computer readable medium according to claim 15, the method further comprising the step of:
if the user identification is received, transmitting, through the communication interface, the second receipt information to the storage unit over a network.

17. The non-transitory computer readable medium according to claim 15, wherein, if the user identification is not received, the instructions cause the processor to not convert the first receipt information to the second receipt information.

18. The non-transitory computer readable medium according to claim 15, wherein whether the user identification is received is determined by determining whether the user identification is included in the first receipt information.

19. The non-transitory computer readable medium according to claim 14, wherein the commodity data is retrieved from a first server and the classification data is retrieved from a second server different from the first server.

20. The method according to claim 18, wherein the storage unit in which the classification data is caused to be stored in correspondence with the second receipt information is in the second server.
